(19) United States
(12) Patent Application Publication
(10) Pub. No.: US 2026/0029518 A1
(43) Pub. Date: Jan. 29, 2026

(54) Window blockage classification for LIDAR system

(71) Applicant: Innoviz Technologies Ltd., Rosh HaAyin (IL)

(72) Inventors: Ran Mor, Herzliya (IL); Idan Bakish, Hod Hasharon (IL)

(21) Appl. No.: 19/278,871

(22) Filed: Jul. 24, 2025

(30) Foreign Application Priority Data
Jul. 28, 2024 (IL) 314587

(51) Int. Cl. G01S 7/497; G01S 7/48

(52) U.S. Cl. CPC G01S 7/497; G01S 7/4802; G01S 2007/4975

(57) ABSTRACT

LIDAR system and method for determining a classification of a window blockage. Emitter of emission unit emits a first illumination beam to illuminate at a first AOI a first blockage region of a window blockage of an optical window of LIDAR system. Emitter emits a second illumination beam to illuminate at a second AOI a second blockage region of window blockage, second blockage region at least partially overlapping first blockage region. Detector of sensing unit receives first blockage reflection of first illumination beam, and receives second blockage reflection of second illumination beam, first blockage reflection having first reflection intensity, and second blockage reflection having second reflection intensity. Processor determines classification of window blockage, based on first reflection intensity of first blockage reflection and first AOI of first illumination beam, and based on second reflection intensity of second blockage reflection and second AOI of second illumination beam.

### TECHNICAL FIELD

The present disclosure relates generally to technologies for scanning a surrounding environment, and particularly, to systems and methods for detecting objects using LIDAR scanning and applicable for vehicle use.

### BACKGROUND

With the advent of driver assistance systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested, such as radar and camera-based systems, operating alone or in a redundant manner.

One consideration with driver assistance systems and autonomous vehicles is an ability to determine surroundings across different environmental conditions, including rain, fog, darkness, bright light, and snow. A light detection and ranging (LIDAR) system is an example of technology that can work well in differing conditions, by measuring distances to objects by illuminating objects with a light source, such as a laser, and measuring the reflected pulses with a sensor. The LIDAR system may include a light deflector for projecting light emitted by the light source into the environment, where the light deflector may be controlled to pivot around at least one axis for projecting the light into a desired location in the field of view. The received reflections may be used to generate a point cloud or depth map representative of spatial locations of objects in the field of view (FOV). For certain applications, the maximum illumination power of a LIDAR system may be limited by eye-safety requirements, so as to avoid damaging of an eye which can occur when a light emission enters an eye which can cause thermal damage of the retina.

LIDAR systems generally include a protective optical window for protecting one or more system elements. For example, the protective window may be part of a housing of the system, or may be an external window, such as part of a vehicle on which the system is deployed, such as a vehicle window or vehicle windshield. The light emitted by the system and the reflections received from the FOV may need to pass through the protective window. Over time, various blockages may form on the protective window which can obstruct the passage of light through the window. For example, a vehicle may be exposed to an assortment of substances and debris in the environment, such as: rain, snow and other forms of precipitation; dirt; dust; mud; soot; leaves; insects; bird droppings; and other miscellaneous detritus. These substances may partially or fully impede the passage of emitted or reflected light through the window. A window blockage may be substantially opaque, such that substantially no light can pass through, or may be at least partially translucent or transparent so as to allow passage of at least some light. A window blockage may limit an amount of incident light (e.g., reflections received from the FOV) and/or alter a direction or pathway of the incident light, such that the light may be steered away from an intended light reception path and may not reach intended sensors. A blockage may be present over only a limited portion of the protective window yet still adversely affect operation of the LIDAR system.

Many LIDAR systems include dedicated mechanisms for monitoring and cleaning of protective windows to minimize the accumulation of blockages. Such blockages can hinder and degrade operational performance, particularly for externally mounted systems that are exposed to dynamically changing conditions, such as vehicles traveling in various terrains, climates, and environments. For example, changes in an amount or direction of incident light due to blockages may result in “false positive” detections, i.e., incorrectly detecting an object in the FOV when no such object is present, as well as “false negative” or “missed detections”, i.e., not detecting an object that is actually present in the FOV. In addition, some LIDAR systems include built-in mechanisms for reducing emissions to an eye-safe level upon detection of close-range objects, and false positive or false negative detections resulting from window blockages may subvert such eye-safe mechanisms.

Accordingly, there is a need to improve operation of LIDAR detection systems subject to window blockages.

### SUMMARY

According to an aspect of the present disclosure, a LIDAR system is provided. The LIDAR system includes an emission unit, a sensing unit, and a processor. The emission unit includes at least one emitter configured to emit a first illumination beam to illuminate at a first angle of illumination (AOI) a first blockage region of a window blockage of an optical window, and configured to emit a second illumination beam to illuminate at a second AOI a second blockage region of the window blockage, the second blockage region at least partially overlapping the first blockage region. The sensing unit includes at least one detector configured to receive a first blockage reflection of the first illumination beam, and to receive a second blockage reflection of the second illumination beam, the first blockage reflection having a first reflection intensity, and the second blockage reflection having a second reflection intensity. The processor is configured to determine a classification of the window blockage, based on the first reflection intensity of the first blockage reflection and the first AOI of the first illumination beam, and based on the second reflection intensity of the second blockage reflection and the second AOI of the second illumination beam.

According to other aspects of the present disclosure, the LIDAR system may include one or more of the following features. The blockage may be classified into a blockage category of: a liquid; a solid; a blockage having a specular surface; and/or a blockage having a non-specular surface. The classification of the window blockage may be based on a reflection intensity profile of intensity of received blockage reflections as a function of AOI of corresponding emitted illumination beams. Determining a classification of the window blockage may include determining a solid blockage or a non-specular blockage when the reflection intensity profile is characterized by a Lambertian pattern, and determining a liquid blockage or a specular blockage when the reflection intensity profile is not characterized by a Lambertian pattern. The first illumination beam and the second illumination beam may be emitted from at least one emitter of an emitter array of the emission unit. The first blockage reflection and the second blockage reflection may be received by at least one detector of a detector array of the sensing unit. The first illumination beam and the second illumination beam may be emitted sequentially. The LIDAR system may further include a scanning unit, configured to direct the first illumination beam to the first blockage region at the first AOI, and to direct the second illumination beam to the second blockage region at the second AOI. The emitter may include: a laser emitter; and/or a light emitting diode (LED) emitter. The processor may be further configured to process reflection characteristics of the first blockage reflection and the second blockage reflection to determine at least one characteristic of the window blockage. The processor may be configured to generate an alert of a classified window blockage. At least one cleaning mechanism for cleaning the window blockage may be configured to be activated responsive to a classified window blockage. The processor may be configured to apply at least one machine-learning generated classification model to the reflection intensity profile, the classification model configured to determine a classification of the blockage based on at least one pattern detected in the reflection intensity profile. The processor may be configured to control at least one of the laser emission unit and the scanning unit to illuminate the first blockage region by the first illumination beam at the first AOI, and to illuminate the second blockage region by the second illumination beam at the second AOI, according to a blockage classification illumination protocol, and the processor may be configured to apply the blockage classification illumination protocol at predefined intervals; at random intervals; and/or responsive to a detection of the window blockage. The window may be a portion of a vehicle. The window may include a hydrophobic coating. A rain treatment mechanism may be activated responsive to a determined classification of a liquid blockage indicative of a precipitation state in an environment of the LIDAR system.

According to another aspect of the present disclosure, a method for determining a classification of a window blockage of a LIDAR system is provided. The method includes emitting a first illumination beam to illuminate at a first AOI a first blockage region of a window blockage of an optical window, and emitting a second illumination beam to illuminate at a second AOI a second blockage region of the window blockage, the second blockage region at least partially overlapping the first blockage region. The method further includes receiving a first blockage reflection corresponding to the first illumination beam, the first blockage reflection having a first reflection intensity, and receiving a second blockage reflection corresponding to the second illumination beam, the second blockage reflection having a second reflection intensity. The method further includes determining a classification of the window blockage, based on the first reflection intensity of the first blockage reflection and the first AOI of the first illumination beam, and based on the second reflection intensity of the second blockage reflection and the second AOI of the second illumination beam.

According to other aspects of the present disclosure, the method may include one or more of the following features. The blockage may be classified into a blockage category of: a liquid; a solid; a blockage having a specular surface; and/or a blockage having a non-specular surface. Determining a classification of the window blockage may include processing a reflection intensity profile of intensity of received blockage reflections as a function of AOI of corresponding emitted illumination beams. Determining a classification of the window blockage may include determining a solid blockage or a non-specular blockage when the reflection intensity profile is characterized by a Lambertian pattern, and determining a liquid blockage or a specular blockage when the reflection intensity profile is not characterized by a Lambertian pattern. The first illumination beam and the second illumination beam may be emitted sequentially. The first illumination beam may be directed to the first blockage region at the first AOI by a scanning unit, and the second illumination beam may be directed to the second blockage region at the second AOI by the scanning unit. The method may further include processing reflection characteristics of the first blockage reflection and the second blockage reflection to determine at least one characteristic of the window blockage. The method may further include generating an alert of a classified window blockage. The method may further include activating at least one cleaning mechanism for cleaning the window blockage, responsive to a classified window blockage. At least one machine-learning generated classification model may be applied to the reflection intensity profile, the classification model configured to determine a classification of the blockage based on at least one pattern detected in the reflection intensity profile. The method may include controlling at least one of the laser emission unit and the scanning unit, to illuminate the first blockage region by the first illumination beam at the first AOI, and to illuminate the second blockage region by the second illumination beam at the second AOI, according to a blockage classification illumination protocol, and the processor may be configured to apply the blockage classification illumination protocol, at predefined intervals; at random intervals; and/or responsive to a detection of the window blockage. The window may be a portion of the vehicle. The window may include a hydrophobic coating. The method may further include activating a rain treatment mechanism responsive to a determined classification of a liquid blockage indicative of a precipitation state in an environment of the LIDAR system.

### BRIEF DESCRIPTION OF THE DRAWINGS

The present disclosure will be more fully understood from the following detailed description of the embodiments thereof, taken together with the drawings in which:

FIG. 1A is a schematic illustration of a LIDAR system, constructed and operative in accordance with an embodiment of the present disclosure;

FIG. 1B is an image of an exemplary output from a single scanning cycle of the LIDAR system of FIG. 1A, in accordance with an embodiment of the present disclosure;

FIG. 2A is a schematic illustration of an exemplary multichannel LIDAR system, constructed and operative in accordance with an embodiment of the present disclosure;

FIG. 2B is a schematic illustration of another exemplary multichannel LIDAR system, constructed and operative in accordance with another embodiment of the present disclosure;

FIG. 3A is an illustration of an exemplary scanning pattern of a field of view obtained using a scanning device, operative in accordance with an embodiment of the present disclosure;

FIG. 3B is an illustration of another exemplary scanning pattern of a field of view obtained using a scanning device, operative in accordance with another embodiment of the present disclosure;

FIG. 4A is an illustration of a first exemplary detector array, constructed and operative in accordance with an embodiment of the present disclosure;

FIG. 4B is an illustration of a second exemplary detector array, constructed and operative in accordance with another embodiment of the present disclosure;

FIG. 4C is an illustration of a third exemplary detector array, constructed and operative in accordance with a further embodiment of the present disclosure;

FIG. 5 is an illustration of exemplary light emissions of a multichannel LIDAR system having a window blockage, operative in accordance with another embodiment of the present disclosure;

FIG. 6 is an illustration of an illumination protocol for blockage classification in a multichannel LIDAR system with a window blockage, operative in accordance with an embodiment of the present disclosure;

FIG. 7A is a spatial representation of an overlay pattern of reflections resulting from emissions incident on exemplary window blockages, operative in accordance with an embodiment of the present disclosure;

FIG. 7B is a graph illustrating reflection intensity profiles of exemplary window blockage reflections as a function of angle of illumination of corresponding emissions, operative in accordance with an embodiment of the present disclosure;

FIG. 8 is a flow diagram of a method for determining a classification of a window blockage of a multichannel LIDAR system, operative in accordance with an embodiment of the present disclosure; and

FIG. 9 is an illustration of a LIDAR system incorporating LED illumination for detecting and classifying window blockages, constructed and operative in accordance with an embodiment of the present disclosure.

### DETAILED DESCRIPTION OF EMBODIMENTS

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to methods and systems for mitigating the effects of window obstructions in LIDAR detection systems. The disclosed methods and systems are directed to maintain object detection capabilities of a LIDAR detection system even when subject to obstructions on a window of the LIDAR system.

Unless otherwise defined, all terms (including technical and scientific terms) used herein have the same meaning as commonly understood by one of ordinary skill in the art to which the disclosed subject matter belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section.

It will be understood that when an element is referred to as being “on”, “attached” to, “operatively coupled” to, “operatively linked” to, “operatively engaged” with, “connected” to, “coupled” with, “contacting”, “added to, another element, it can be directly on, attached to, connected to, operatively coupled to, operatively engaged with, coupled with, added to, and/or contacting the other element or intervening elements can also be present. In contrast, when an element is referred to as being “directly contacting” another element or “directly added” to another element, there are no intervening elements present.

Whenever the term “about” or “approximately” is used, it is meant to refer to a measurable value such as an amount, a temporal duration, and the like, and is meant to encompass variations (e.g., ±20%, ±10%, ±5%, ±1%, ±0.1%) from the specified value, as such variations are appropriate to perform the disclosed methods.

Certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Whenever terms “plurality” and “a plurality” are used it is meant to include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Throughout, this disclosure mentions “disclosed embodiments”, “disclosed systems” and “disclosed methods”, which refer to examples of inventive ideas, concepts, and/or manifestations described herein. The fact that some disclosed embodiments are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

The term “repeatedly” as used herein should be broadly construed to include any one or more of: “continuously”, “periodic repetition” and “nonperiodic repetition”, where periodic repetition is characterized by constant length intervals between repetitions and non-periodic repetition is characterized by variable length intervals between repetitions.

The terms “user” and “operator” are used interchangeably herein to refer to any individual person or group of persons using or operating a method or system in accordance with disclosed embodiments.

Disclosed embodiments are described herein for exemplary purposes in the context of a vehicle-mounted LIDAR system for driving assistance applications but may be further applicable in other contexts and uses. The term “vehicle” should be broadly interpreted to refer to any type of vehicle or transportation device operating in any environment (e.g., air, land or sea), including but not limited to: automobiles, buses, vans, trucks, motorcycles; aircrafts or maritime vessels; unmanned aerial vehicles (drones); electric or hybrid vehicles; electric bicycles (e-bikes); electric scooters (e-scooters); and the like.

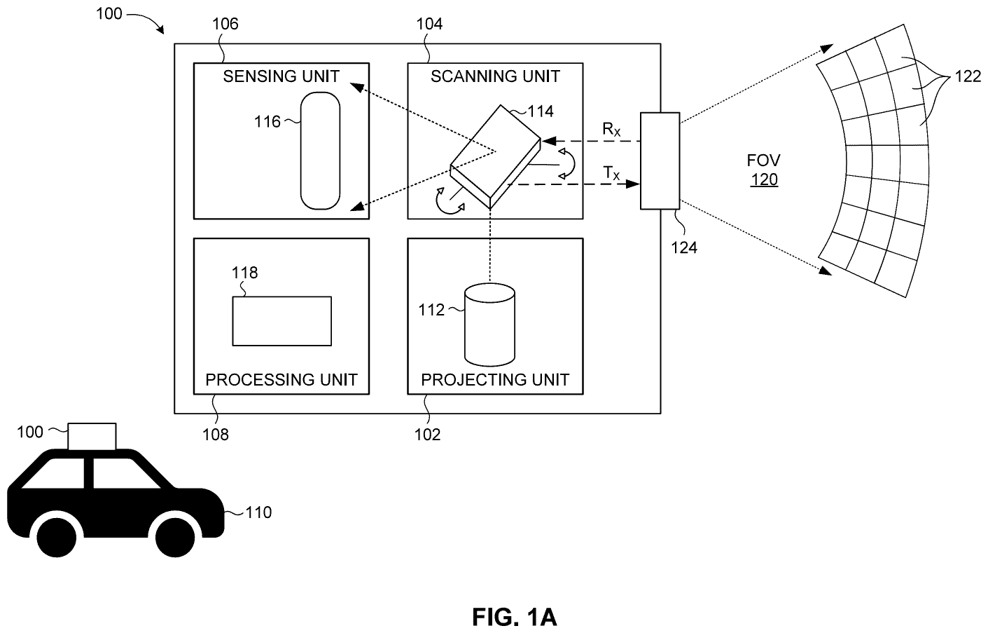

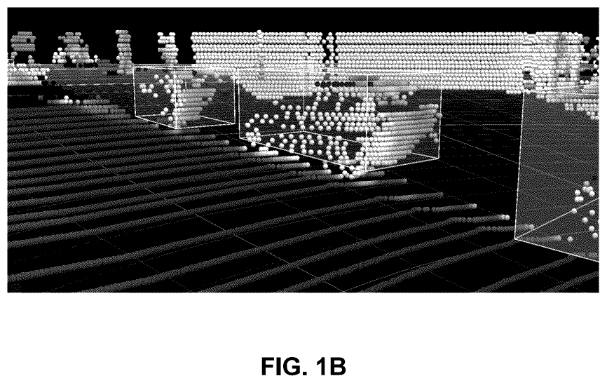

Reference is made to FIG. 1A, which is a schematic illustration of a LIDAR system, generally referenced 100, constructed and operative in accordance with a disclosed embodiment. LIDAR system 100 includes a projecting unit 102, a scanning unit 104, a sensing unit 106, and a processing unit 108. Projecting unit 102 includes at least one light source 112. Scanning unit 104 includes at least one light deflector 114. Sensing unit 106 includes at least one sensor 116. Processing unit 108 includes at least one processor 118. LIDAR system 100 may be mounted on a vehicle 110. Projecting unit 102 projects light towards an environment of LIDAR system 100, such as towards an environment around vehicle 110. Scanning unit 104 directs projected light towards the environment to scan a field of view (FOV) 120 around vehicle 110, and directs reflected light from the environment to sensing unit 106. Sensing unit 106 receives reflections from the surroundings of vehicle 110 and sends reflections signals indicative of light reflected from objects in FOV 120 to processing unit 108. LIDAR system 100 optionally includes at least one optical window 124, where projected light directed towards FOV 120 passes through optical window 124 and/or reflected light reflected from objects in FOV 120 passes through optical window 124. Optical window 124 may include or be associated with an optical assembly for manipulating one or more characteristics of projected or reflected light, such as collimating of projected light or focusing of reflected light. Optical window 124 may be embodied, for example, by an opening, a flat window, a lens, or another type of optical element.

At least a portion of LIDAR system 100 may be mounted to or incorporated into a portion of vehicle 110, such as: a bumper, a fender, a side panel, a spoiler, a roof, a headlight assembly, a taillight assembly, a rear-view mirror assembly, a hood, a trunk or any other suitable part of vehicle 110 capable of housing at least a portion of LIDAR system 100. In some embodiments, LIDAR system 100 may capture a complete surround view of the environment of vehicle 110, such as being characterized by a 360-degree horizontal field of view. In one example, LIDAR system 100 may include a single scanning unit 104 mounted on a roof of vehicle 110. In another example, LIDAR system 100 may include multiple scanning units 104, each having a respective field of view (e.g., 75° to 120° field of view). For example, vehicle 110 may employ a first LIDAR system 100 having a first FOV directed in a forward direction of the vehicle, and optionally a second LIDAR system 100 with a second FOV, directed in a backward direction (e.g., optionally with a lower detection range). It is also noted that one or more LIDAR systems 100 may be characterized by different vertical field of view angles.

The term “field of view of the LIDAR system” may broadly include an extent of the observable environment of the LIDAR system in which objects may be detected. Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and can be moved within the FOV of the LIDAR system in order to enable detection in other parts of the FOV of the LIDAR system.

Light source 112 of projecting unit 102 is configured to emit light, such as a series of light pulses, towards the environment. Light source 112 may be a laser, such as a solid-state laser or a semiconductor laser or laser diode, or an alternative light source, such as a light-emitting diode (LED). For example, light source 112 may include a plurality of laser diodes coupled together. For example, light source 112 may be embodied by a vertical-cavity surface-emitting laser (VCSEL), or alternatively by an external cavity diode laser (ECDL). In some examples, light source 112 may emit light at a wavelength between about 650 nm and about 1150 nm, such as between about 800 nm and about 1000 nm, such as between about 850 nm and about 950 nm. In other examples, light source 112 may emit light at a wavelength between about 1300 nm and about 1600 nm. In some examples, the light emitted by light source 112 may have an average power between about 50 mW and about 500 mW, may have a peak power between about 50 W and about 200 W, and may have a pulse width of between about 2 ns and about 100 ns. Light source 112 may emit light in different formats, such as light pulses, frequency modulated, continuous wave (CW), quasi-CW, or any other form corresponding to the particular light source employed. The projection format and other parameters may be changed periodically by light source 112 based on selected factors, such as based on the scanned FOV and/or environmental conditions, such as according to instructions from processing unit 108.

Light deflector 114 of scanning unit 104 directs emitted light emitted from light source 112 towards at least part of FOV 120, and directs reflected light from at least part of FOV 120 towards sensor 116. For example, scanning unit 104 may include a first (outbound) light deflector 114 for directing light in an outbound direction (also referred to as a transmission direction or “Tx”) from light source 112 to FOV 120, and a second (inbound) light deflector 114 for directing light in an inbound direction (also referred to as a reception direction or “Rx”) reflected from FOV 120 to sensor 116. Light deflector 114 may be pivoted (i.e., rotated about at least one rotational axis while substantially maintaining a center of rotation fixed) in order to scan the field of view. Light deflector 114 may include at least one component or mechanism configured to deviate light from an original path, such as: a mirror, a prism, a controllable lens, a mechanical mirror, mechanical scanning polygons, active diffraction (e.g., controllable LCD), Risley prisms, non-mechanical-electro-optical beam steering, polarization grating, optical phased array (OPA), and the like. Light deflector 114 may include a plurality of optical elements, such as at least one reflecting element (e.g., a mirror), and at least one refracting element (e.g., a prism, a lens). Light deflector 114 may be movable, such as to cause a light deviation of differing degrees (e.g., discrete degrees, or over a continuous span of degrees). Light deflector 114 may be controllable in different ways, such as to deflect a selected degree amount (e.g., α), to change a deflected angle amount (e.g., Δα), to move a component of light deflector 114 by a certain amount (e.g., M millimeters), and/or to change a rate of change of a deflection angle. Light deflector 114 may be operable to change an angle of deflection within a single plane (e.g., θ coordinate), or to change an angle of deflection within two non-parallel planes (e.g., θ and ϕ coordinates). Alternatively or additionally, light deflector 114 may be operable to change an angle of deflection between predetermined settings (e.g., along a predefined scanning route).

Scanning unit 104 may receive reflections from at least one portion 122 of FOV 120 corresponding to an instantaneous position of light deflector 114, broadly referring to a location or spatial position where at least one controlled component of light deflector 114 is situated at an instantaneous point in time or a short time span. An instantaneous position of light deflector 114 may be determined with respect to a frame of reference, such as at least one fixed point in the scene. An instantaneous position of light deflector 114 may include movement of at least one component of light deflector 114, such as to a limited degree with respect to a maximum degree of change when scanning FOV 120. For example, a scanning of entire FOV 120 may include changing deflection of light over a first angular range (e.g., 0.30°, and the instantancous position of light deflector 114 may include angular shifts of the light deflector within a second (narrower) angular range (e.g.,) 0.05°. An instantaneous position of light deflector 114 may correspond to at least one spatial position of light deflector 114 during acquisition of reflected light which is processed to provide data for a single point of a point cloud generated by LIDAR system 100. In some examples, an instantaneous position of light deflector 114 may correspond with a fixed position or orientation in which light deflector 114 pauses for a short time during illumination of a particular sub-region of FOV 120. In some examples, an instantaneous position of light deflector 114 may correspond with a position or orientation along a scanned range of positions or orientations light deflector 114 passes through as part of a repeated scan of FOV 120. Light deflector 114 may be moved such that light deflector 114 is located at a plurality of different instantaneous positions during a scanning cycle of FOV 120. In other words, during a period in which a scanning cycle occurs, light deflector 114 may be moved through a series of different instantaneous positions and orientations, and light deflector 114 may reach each different instantaneous position and orientation at a different time during the scanning cycle.

Sensor 116 of sensing unit 106 detects reflections from one or more objects in FOV 120. Sensor 116 may be any type of sensing device or element capable of measuring properties (e.g., power, frequency, phase, pulse timing, pulse duration) of electromagnetic radiation, and generating an output relating to the measured properties, such as an electronic signal, for subsequent processing and/or transmission. Sensor 116 may include multiple sensors, which may be the same or different in at least one sensor characteristic (e.g., sensitivity, resolution, size). For example, sensor 116 may include a combination of sensor types for achieving at least one selected objective, such as: improving detection over a span of ranges or a selected range (e.g., close range); improving a dynamic range; improving a temporal response; and improving detection in varying environmental conditions (e.g., heat, cold, rain, snow, fog, low visibility, and the like). For example, sensor 116 may be embodied by a silicon photomultiplier (SiPM) sensor, which is a solid-state single photon sensitive device which may include an array of avalanche photodiodes (APD) or single photon avalanche diodes (SPAD) serving as detection elements on a common silicon substrate. In one example, a typical distance between SPADs may be between about 10 μm and about 50 μm, wherein each SPAD may have a recovery time of between about 20 ns and about 100 ns. Sensor 116 may also include similar photomultipliers from other (e.g., non-silicon) materials. Although a SiPM device works in digital/switching mode, an SiPM may be considered an analog device because all the microcells may be read in parallel, making it possible to generate signals within a dynamic range from a single photon to hundreds and thousands of photons detected by the different SPADs. Sensor 116 may generate a single output combined from multiple types of sensors for subsequent processing. The terms “sensor” and “detector” may be used interchangeably herein.

Processor 118 receives information from elements of LIDAR system 100 and performs required data processing. For example, processor 118 receives signals indicative of reflected light detected by sensor 116 and determines information about one or more objects in FOV 120 (e.g., a distance to an object), such as based on generating a point cloud map. Specifically, processor 118 may process detection results of a sensor that creates temporal information indicative of a period of time between the emission of a light signal (i.e., emitted beam) and the time of its detection by the sensor, where this period time may be referred to as a “time of flight” of the light signal. Processor 118 may further receive and provide instructions and may selectively control the operation of system elements. For example, processor 118 may be configured to coordinate the operation of light source 112 with the movement of light deflector 114 in order to scan FOV 120, such that during a scanning cycle, each instantaneous position of light deflector 114 may be associated with a particular portion 122 of FOV 120.

Processor 118 may constitute any physical device or group of devices having electric circuitry that performs a logic operation on an input or inputs. For example, processor 118 may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by the processor may, for example, be pre-loaded into a memory integrated with or embedded into the controller or may be stored in a separate memory. The memory may include: a random access memory (RAM); a read-only memory (ROM); a hard disk; an optical disk; a magnetic medium; a flash memory; other permanent, fixed, or volatile memory; or any other mechanism capable of storing instructions. Processor 118 may include multiple processors. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, acoustically, mechanically or by other means that permit them to interact.

The components of LIDAR system 100 may be based in hardware, software, or combinations thereof. It is appreciated that the functionality associated with each of the components of LIDAR system 100 may be distributed among multiple devices or components, which may reside at a single location or at multiple locations. For example, the functionality associated with processor 118 may be distributed between a single processing unit or multiple processing units. Processor 118 may be part of a server or a remote computer system accessible over a communications medium or network, such as a cloud computing platform.

LIDAR system 100 may optionally include and/or be associated with additional components not shown in FIG. 1A, for enabling implementation of disclosed subject matter. For example, LIDAR system 100 may include a user interface (not shown) for allowing a user to control various parameters or settings of components of LIDAR system 100, and/or a display device (not shown) for visually displaying information relating to the operation of LIDAR system 100.

Reference is made to FIG. 1B, which is an image of an exemplary output from a single scanning cycle of LIDAR system 100, in accordance with a disclosed embodiment. In this example, scanning unit 104 is incorporated into a right headlight assembly of vehicle 110. Each gray dot in the image corresponds to a respective location in the environment around vehicle 110 determined from reflections detected by sensing unit 106. In addition to location, each gray dot may also be associated with other types of information, such as intensity (e.g., amount of received light from the respective location), reflectivity, proximity to other dots, and the like. LIDAR system 100 may generate a plurality of point cloud data entries from detected reflections of multiple scanning cycles of the FOV to enable, for example, determining a point cloud model of the environment around vehicle 110. By processing the generated point cloud data entries of the environment around vehicle 110, a surround-view image may be produced from the point cloud model. The point cloud model may be provided to a feature extraction module, which processes the point cloud information to identify a plurality of features. Each feature may include data about different aspects of the point cloud and/or of objects in the environment around vehicle 110 (e.g., cars, trees, people, and roads). Features may have the same resolution of the point cloud model (i.e., having the same number of data points, optionally arranged into similar sized 2D arrays), or may have different resolutions. In addition, virtual features, such as a representation of vehicle 110, border lines, or bounding boxes separating regions or objects in the image (e.g., as depicted in FIG. 1B), and icons representing one or more identified objects, may be overlaid on the representation of the point cloud model to form a final surround-view image. For example, a symbol of vehicle 110 may be overlaid at a center of the surround-view image.

A point cloud model represents an exemplary type of depth map, where other forms of 3D scene models or depth images may alternatively be generated in accordance with disclosed embodiments. LIDAR system 100 may generate a temporal sequence of depth maps of a scene, in which different depth maps may be generated at different times. Each depth map of a sequence may be associated with a scanning cycle, also referred to herein as a “frame”, where each frame is generated at a selected frame rate. LIDAR system 100 may employ a fixed frame rate (e.g., 10 Hz, 25 Hz, 50 Hz), or a dynamic frame rate, and the frame rates of different frames in a sequence may be variable.

According to an aspect of the present disclosure, the LIDAR system may operate in a multi-beam scanning or multichannel configuration. In particular, LIDAR system 100 may be configured with a plurality of light sources 112 to enable scanning of different portions of a FOV or for scanning the FOV in a differential manner using pulses with different light emission properties (e.g., intensity, wavelength, frequency, power, pulse width, modulation, duty cycle). For example, light source 112 may include a plurality of individual light sources that may be characterized by common or different light emission types or properties and may operate in a coordinated manner. For example, light source 112 may be embodied by a multichannel laser emitter configured to emit multiple light beams, where each channel emits a respective light beam having respective light emission properties toward a respective portion of FOV 120.

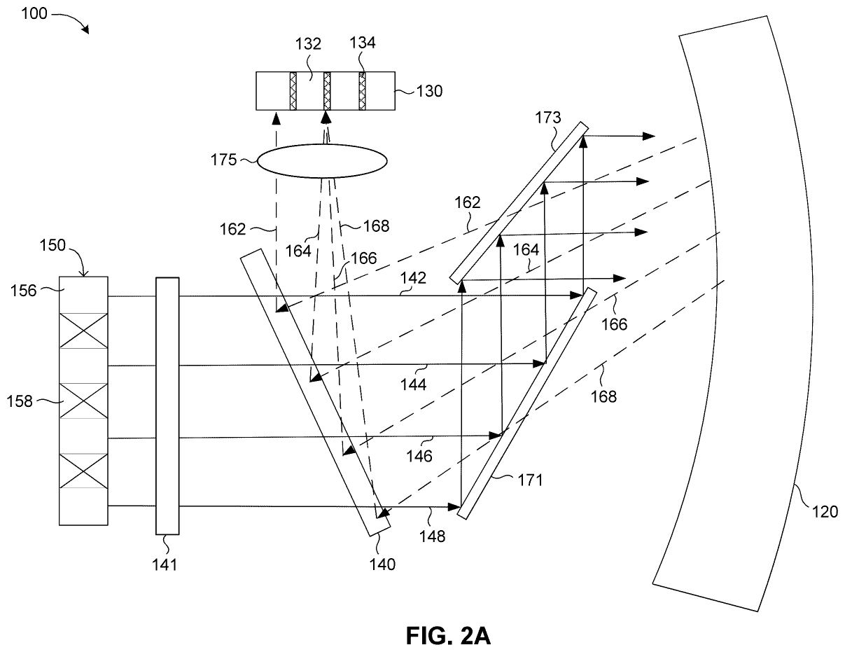

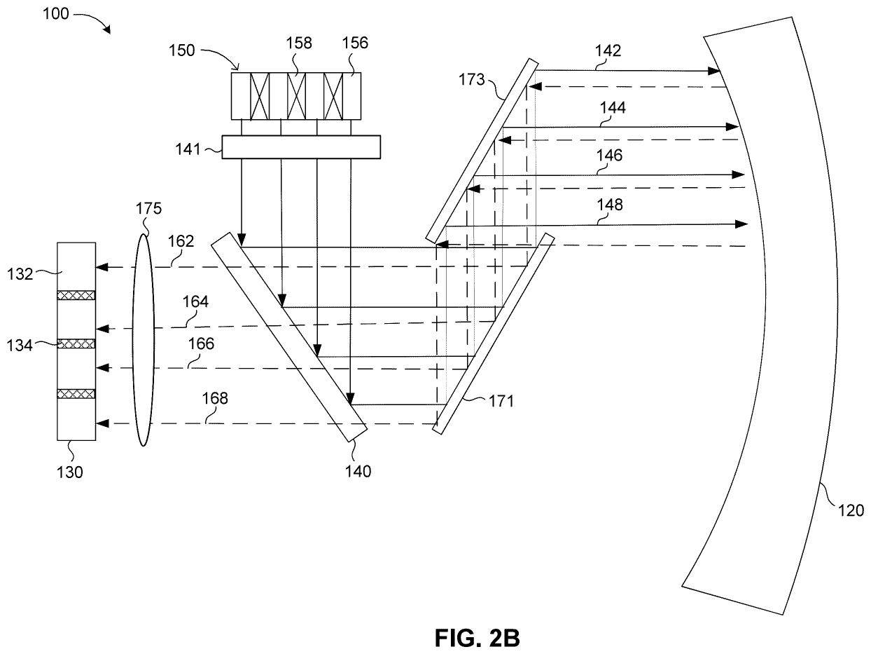

Reference is made to FIG. 2A, which is a schematic illustration of an exemplary multichannel LIDAR system 100, constructed and operative in accordance with another embodiment of the present disclosure. LIDAR system 100 includes a multichannel laser emitter array 150, a beam splitter 140, an optional collimator 141, a plurality of light deflectors 171, 173, at least one lens 175, and a multichannel detector array 130. Laser emitter array 150 includes a plurality of laser emitters configured to selectively emit respective light beams. Laser emitter array 150 may include a plurality of active regions and a plurality of inactive regions, where each active region is configured to emit laser light (i.e., corresponding to a laser emitter), and each inactive region does not emit laser light. The active regions of the laser array may be separated from each other by one or more inactive regions. Accordingly, laser array 150 includes a plurality of laser-emitting active regions 156 and a plurality of non-laser emitting inactive regions 158, where each active region 156 corresponds to a channel. For example, laser array 150 may be a quad array that includes four active regions 156 or channels, such as four laser sources configured to respectively emit four laser beams 142, 144, 146, 148. Multiple beams may also be generated by a single emitted laser beam split into multiple beams, such as splitting a single beam emitted by a single emitter. Laser array 150 may generally include any number of active regions or channels or laser sources, such as 8, 16, 32 or 64. Each pair of active regions 156 of laser array 150 is separated by at least one inactive region 158. The sizes of active regions 156 and of inactive regions 158 may be equal or unequal. For example, laser array 150 may include an alternating and repeating sequence of active regions 156 or emitters adjacent to one inactive region 158 of equal size. Laser array 150 may be a monolithic array of laser sources that may be fabricated on a single (e.g., monolithic) silicon wafer. Laser array 150 may include one or more types of emitters or laser sources, which may be arranged in a one-dimensional (1D) array or two-dimensional (2D) array. The laser sources may be arranged in any type of pattern, such as a square or rectangular pattern, or hexagonally packed arrangement.

The light emitted from the laser sources may travel through various optical components associated with the optical path, such as one or more lenses, collimators, and deflectors. In particular, laser array 150 emits multiple laser beams 142, 144, 146, 148, which are optionally collimated by at least one collimator 141 before being incident on beam splitter 140. At least some of the emitted beams 142, 144, 146, 148 may be emitted with a divergence, such that respective emitted beams 142, 144, 146, 148 diverge from one another when emerging from laser array 150, where the amount or angle or divergence of different beams may be variable. Multiple emitted beams 142, 144, 146, 148 pass through beam splitter 140 and are directed by light deflectors 171, 173 to a FOV 120. Multiple reflected beams 162, 164, 166, 168 reflected from one or more objects in FOV 120 are received at beam splitter 140 and then focused on detector array 130 through lens 175. Reflected beams 162, 164, 166, 168 may optionally be directed towards beam splitter 140 by at least one deflector 171, 173.

Detector array 130 may include a plurality of detectors configured to selectively detect respective reflected beams 162, 164, 166, 168 reflected from FOV 120, and to generate electrical signals response of received reflected beams for detecting one or more objects in the FOV. Detector array may include a plurality of active regions and a plurality of inactive regions, where each active region is configured to detect laser light (i.e., a light sensitive region corresponding to a detector), and each inactive region does not detect light (i.e., is not light sensitive). The active regions of the detector array may be separated from each other by one or more inactive regions. Accordingly, detector array 130 includes a plurality of light-sensitive active regions 132 and a plurality of inactive regions 134, where each active region 132 corresponds to a channel. For example, detector array 130 may be a quad array that includes four active regions 132 or channels, such as four detectors configured to respectively detect four reflected beams 162, 164, 166, 168. Detector array 130 may generally include any number of active regions or channels or detectors, such as 8, 16, 32 or 64. Each pair of active regions 132 of detector array 130 is separated by at least one inactive region 134. The sizes of active regions 132 and of inactive regions 1134 may be equal or unequal. For example, detector array 130 may include an alternating and repeating sequence of active regions 132 adjacent to one inactive region 134 of equal size. Detector array 130 may be a monolithic array of detectors that may be fabricated on a single (e.g., monolithic) silicon wafer. Active regions 132 may include one or more types of detectors, which may be arranged in a one-dimensional (1D) array or two-dimensional (2D) array. For example, detector array 130 may be embodied by a multichannel SiPM sensor array or SPAD array or an APD array.

In an alternative embodiment, the beam splitter may redirect the multiple emitted beams and pass through the multiple reflected beams, rather than passing through the multiple emitted beams and redirecting the multiple reflected beams (as depicted in FIG. 2A). Reference is made to FIG. 2B, which is a schematic illustration of another exemplary multichannel LIDAR system 100, constructed and operative in accordance with another embodiment of the present disclosure. LIDAR system 100 of FIG. 2B is generally analogous to LIDAR system 100 of FIG. 2A, with the exception that multiple emitted beams 142, 144, 146, 148 emitted by laser array 150 are reflected or redirected by beam splitter 140 towards light deflectors 171, 173, which in turn direct the emitted beams 142, 144, 146, 148 toward FOV 120. Emitted beams 142, 144, 146, 148 may optionally be collimated by at least one collimator 141 before being incident on beam splitter 140. Multiple reflected beams 162, 164, 166, 168 are reflected from one or more objects in FOV 120 and redirected by light deflectors 171, 173 towards beam splitter 140, which passes through reflected beams 162, 164, 166, 168 to detector array 130 through lens 175. Reflected beams 162, 164, 166, 168 may optionally reach beam splitter 140 without being directed by at least one deflector 171, 173. It is noted that beam splitter 140, collimator 141, light deflectors 171, 173, and lens 175 represent exemplary optical elements in exemplary configurations, and alternative elements and/or configurations may be applied for directing emitted beams or reflected beams in accordance with disclosed embodiments.

Referring back to FIG. 1, scanning unit 104 of LIDAR system 100 may be configured to project a plurality of laser beams emitted by a multichannel laser array towards a FOV 120 of LIDAR system 100, to simultaneously scan the FOV along a plurality of scan lines. Scanning unit 104 may include one or more optical components (e.g., described as light deflector 114 in FIG. 1), configured to receive and direct the plurality of laser beams to scan the FOV. For example, scanning unit 104 may include at least one of: a light-transmissive scanning prism; a diffraction scanner; a liquid crystal on silicon (LCoS) scanner; a single biaxial scanning mirror; a pair of single-axis scanning mirrors; a liquid crystal deflector; a MEMS mirror; and the like. Referring to FIGS. 2A and 2B, multiple emitted beams 142, 144, 146, 148 emitted by laser array 150 and redirected or passed through by beam splitter 140 may be incident on a scanning device (not shown), such as a mechanically actuated biaxial scanning mirror, or a plurality or mirrors (e.g., an array of MEMS mirrors). It will be appreciated that such a configuration may provide for multiple beams that are spaced apart and that have an intensity below an eye safety threshold at different ranges. Furthermore, multiple beams projected from a single scanning mirror may be vertically or horizontally arranged relative to one another, which may result in an extended vertical FOV as compared to individual beams incident on a mirror or multi-beam configurations that lack a vertical spot orientation in the FOV.

Scanning unit 104 may include a biaxial scanning mirror that is rotatable in two axes, such as two substantially orthogonal axes. For example, a first axis of rotation referred to as a “tilt axis” allows for tilting of scanning unit 104 to direct a plurality of laser beams in a vertical (i.e., up/down) direction of a FOV, and a second axis of rotation referred to as a “scan axis” allows for scanning of scanning unit 104 to direct the plurality of laser beams in a horizontal (i.e., left/right) direction of the FOV. The biaxial scanning mirror may be actuated using a suitable actuation mechanism (e.g., motor driven actuation, magnetic actuation, and the like). Rotation of the biaxial scanning mirror about the scanning axis may direct the plurality of laser beams to move along a plurality of scan lines traversing the FOV.

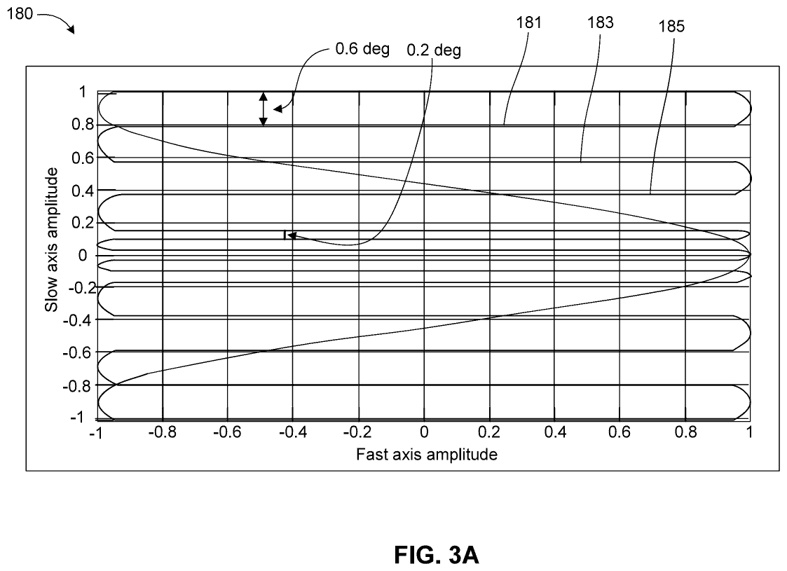

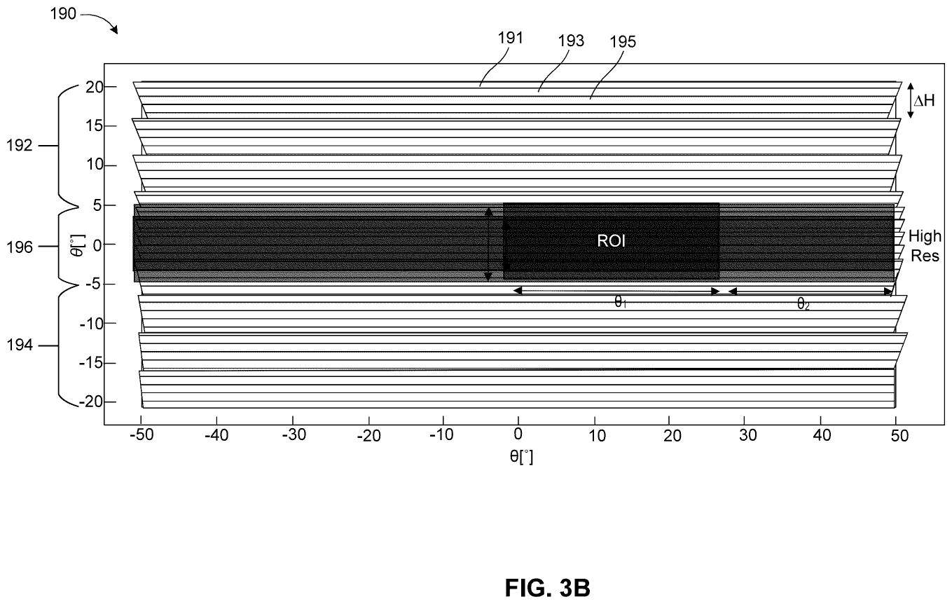

Reference is made to FIG. 3A, which is an illustration of an exemplary scanning pattern of a field of view obtained using a scanning device, operative in accordance with an embodiment of the present disclosure. A 2D scanning device, such as a mechanically actuated biaxial scanning mirror, directs a plurality of laser beams emitted from a laser emitter array over the illustrated scanning pattern, referenced 180. The y-axis represents a “slow axis amplitude” (e.g., of a tilt axis) and the x-axis represents a “fast axis amplitude” (e.g., of a scan axis) of scanning pattern 180, where the values on the axes are normalized to a maximum amplitude of the scan such that the maximum amplitude is 1. For example, sequentially rotating the scanning device over a scan axis may direct the laser beams along a plurality of points in a horizontal direction, e.g., a left to right direction, as represented by scan line 181. Further sequentially rotating the scanning device over a tilt axis may direct the laser beams along a plurality of points in a vertical direction, e.g., an up to down direction. A combination of the aforementioned 2D movements of the scanning unit may generate scanning pattern 180, including horizontal scan lines 181, 183, 185. It is noted that horizontal scan lines 181, 183, 185 may not be evenly spaced. For example, to scan certain regions of the FOV, such as the areas above and below a center region, a vertical tilt increment for the scanning device may be selected that is greater than a minimum available tilt increment. The regions above and below the center of the scan may be scanned using a vertical tilt increment different from the center of the scan, which may be directed at the horizon. For example, the regions above and below the center of the scan may be scanning using a vertical tilt increment of about 0.6°, which may correspond to an angular size of the entire laser array, thus generating a coarse sampling resolution equal to the laser pitch in the laser array. The laser pitch refers to the center-to-center distance between active (light emitting) regions of the laser array. For a selected scan region, such as a region including the center of the scan, a minimum vertical tilt angle can be used to provide more closely spaced scan lines in that region, and thus a higher sampling rate or point cloud resolution in the selected scan region. For example, a center region of the FOV (e.g., a region of interest) may be associated with regions near the horizon and may typically include more distant objects or higher densities of objects of interest and may thus be scanned at a higher resolution. In contrast, a top region or bottom region of the FOV may be associated with regions further from the horizon and may typically include more nearby objects or fewer objects of interest and may thus be scanned at a lower resolution. The vertical point cloud resolution may depend on the scan line spacing, while the horizontal point cloud resolution may depend on the frequency at which a laser emitter is pulsed as the scanning device scans along each horizontal scan line, where a higher pulse frequency corresponds to a higher potential horizontal resolution of the generated point cloud.

When the scanning device receives a plurality of laser beams emitted by a laser array (e.g., laser array 150), and optionally directed by a beam splitter (e.g., beam splitter 140), a first rotation of the scanning device about a scan axis may produce a plurality of horizontal scan lines traversing a first set of locations, and a second rotation of the scanning device about a tilt axis may shift the horizontal scan line vertically, thereby producing a second set of scan lines traversing a second set of locations vertically spaced from the first set of locations. A rate of rotation of the scanning device about the scan axis may be faster than a rate of rotation about the tilt axis.

Reference is made to FIG. 3B, which is an illustration of another exemplary scanning pattern of a field of view obtained using a scanning device, operative in accordance with another embodiment of the present disclosure. A scanning device directs a plurality of laser beams over the illustrated scanning pattern, generally referenced 190. The y-axis represents a vertical scanning angle of scanning pattern 190 (depicted in 5-degree increments) and the x-axis represents a horizontal scanning angle of scanning pattern 190 (depicted in 10-degree increments). A first rotation of the scanning device about a scan axis directs the emitted laser beams along a plurality of horizontal scan lines 191, 193, 195. A second rotation of the scanning device about a tilt axis causes a vertical displacement of horizontal scan lines 191, 193, 195 by a distance ΔH.

The scanning device may be capable of rotating about multiple rotation axes, or may alternatively include one or more optical components (e.g., mirrors or deflectors), each of which is respectively rotatable about only a single rotation axis. For example, the scanning device may include a first single-axis scanning mirror and a second single-axis scanning mirror, such that the first single axis scanning mirror receives a plurality of laser beams from a laser emitter array and directs the laser beams to the second single-axis scanning mirror which directs the laser beams towards the FOV. For example, the first single-axis scanning mirror rotates about a first rotation axis (e.g., a scan axis) to move the laser beams along a first plurality of scan lines traversing the FOV, and the second single-axis scanning mirror rotates about a second rotation axis (e.g., a tilt axis) to displace the laser beams from a first set of locations associated with the first plurality of scan lines to a second set of locations associated with a second plurality of scan lines, to generate a scanning pattern such as patterns 180, 190. For example, referring back to FIGS. 2A, 2B, a first single-axis scanning mirror may be embodied by first light deflector 171 and a second single-axis scanning mirror may be embodied by second light deflector 173. First deflector 171 may be rotatable about a first axis, such as a horizontal axis or scan axis, in a left-right direction, such that multiple beams 142, 144, 146, 148 generate horizontal scan lines, such as scan lines 191, 193, 195 (FIG. 3B). Second deflector 173 may be rotatable about a second axis perpendicular to the first axis, such as a vertical axis or tilt axis, in an up-down direction, such that horizontal scan lines 191, 193, 195 are shifted by a vertical displacement AH.

The scanning device may rotate about a scan axis and/or a tilt axis to project laser beams over a desired FOV. Reflected beams from the FOV may be received at a detector to detect the presence of one or more objects in the FOV. The FOV of LIDAR system 100 may have a vertical angular dimension of between 6 degrees and 90 degrees, and the FOV may have a horizontal angular dimension of between 20 degrees and 140 degrees. The extent of the FOV may depend on several factors, such as the maximum rotation span of the scanning device about respective scan and tilt axes, a divergence angle of the laser beams, and the angle between the plurality of laser beams projected from the scanning device.

Scanning of the field of view may be implemented repeatedly over a given frame scan rate to continuously detect changing positions of an object in the FOV. For example, the FOV of LIDAR system 100 may be scanned at a frame scan rate of between 5 Hz and 40 Hz, such as 20 Hz (i.e., 20 times per second). The scan rate may be adjustable in accordance with application requirements. The frame scan rate may define at least one angular dimension size of a laser beam spot of a respective projected laser beam. For example, a plurality of laser beams projected from the scanning device to the FOV may result in corresponding reflected beams, each forming a beam spot having an angular size, such as 0.07 degrees×0.11 degrees. The vertical arrangement of the beam spots may depend on the configuration of the emitters of the laser emitter array, where the distance between adjacent emitters may correspond to spacing between the reflected beam spots. For example, a laser beam spot may have a vertical angular dimension of 0.1 degrees, and may be spaced apart from an adjacent beam spot by about 0.2 degrees (i.e., corresponding to a 2:1 ratio of inactive regions to active regions of the laser emitter array). If the laser array includes 16 channels, an overall vertical pattern (also referred to herein as a “comb”) of projected beams may occupy an angular height of about 4.6 degrees. This comb may be steered horizontally across the width of the FOV by the scanning device, where the horizontal resolution may be determined by the scanning speed and by the laser pulse rate. When the horizontal limit is reached, the scanning device may be incremented vertically (e.g., rotated about the tilt axis) to continue horizontal scanning of the FOV along a new group of horizontal scan lines. It is appreciated that a vertical comb pattern scanned horizontally over the FOV represents an exemplary scanning configuration, and other embodiments may include a horizontal comb that is scanned vertically over the FOV, such as using a horizontally oriented laser array.

The rotation of the scanning device in at least one axis may be controlled to provide a variable resolution scan. For example, in scanning pattern 190, for regions 192 and 194 at the top and bottom of the scan, respectively, the scanning device may be rotated about the vertical tilt axis by an angular increment at least as large as the angular dimension of the laser array. However, in region 196 at the center of the scan (e.g., between +/−5 degrees), which may include the horizon, the scanning device may be rotated about the vertical tilt axis by an angular increment less than the angular dimension of the laser array. For example, a laser array having 8 channels, where the angular width of each emitted laser beam is 0.1° and the angular width of the spacing between adjacent emitted laser beams is 0.2°, defines a total angular dimension of 2.4°. For such a laser array, the vertical rotation of the scanning device in top scan region 192 and bottom scan region 194 may be in angular increments greater than 2.4°, while the vertical rotation in center scan region 196 may be in angular increments less than 2.4° to provide a higher scan resolution in center scan region 196.

A multichannel LIDAR system 100 may include a plurality of detectors configured to emit electrical signals in response to multiple reflected beams received from the FOV. For example, detector array 130 (FIG. 2A, 2B) includes a plurality of detectors, each detector operative for detecting a selected reflected beam 162, 164, 166, 168 received from FOV 120. Each detector corresponds to an active region, which can also be considered an individual “pixel”, which is separated from an adjacent active region by one or more inactive regions of variable spacing. The terms “detector”, “active region (of a detector)” and “pixel” are used interchangeably herein to refer to a discrete unit of a detector array configured to generate a discrete electrical signal response of an incident reflection.

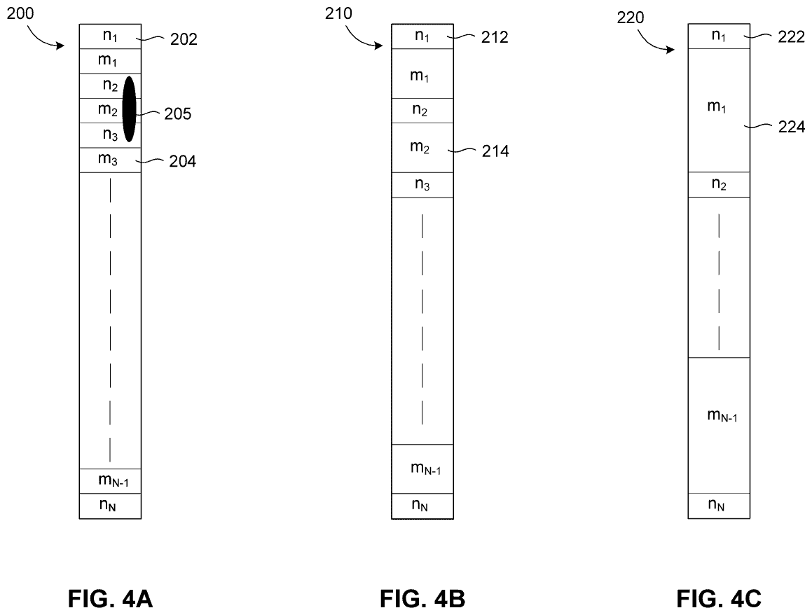

Reference is made to FIGS. 4A, 4B, 4C. FIG. 4A is an illustration of a first exemplary detector array 200, FIG. 4B is an illustration of a second exemplary detector array 210, and FIG. 4C is an illustration of a third exemplary detector array 220, constructed and operative in accordance with embodiments of the present disclosure. Each of detector arrays 200, 210, 220 is a monolithic 1D array that includes N active regions labelled “n” (n₁ to n_{N}) and N-1 inactive regions labelled “m” (m₁ to m_{N-1}), where N may be any desired number (e.g., 4, 8, 16, 32,64). Each pair of active regions is separated by a respective inactive region having a selected width. Detector array 200 includes alternating and repeating sequences of active regions 202 spaced apart by one inactive region 204 of equal size to each active region 202, defining a 1:1 size ratio of active to inactive regions. Detector array 210 includes alternating and repeating sequences of active regions 212 spaced apart by a respective inactive region 214 having twice the width of an active region 212, such that the size ratio of active to inactive regions is 1:2. Detector array 220 includes alternating and repeating sequences of active regions 222 spaced apart by a respective inactive region 224 having five times the width of an active region 212, such that the size ratio of active to inactive regions is 1:5. In general, the spacing between active regions (or the relative width of an inactive region) of a detector array of a multichannel LIDAR system of the present disclosure may be any desired number.

When receiving a plurality of reflected beams from the FOV, each reflected beam may form a respective beam spot on one or more active regions of the detector array. For example, referring to FIG. 4A, detector array 200 includes an exemplary beam spot 205 incident on multiple active regions 202 (e.g., active regions n₂, n₃) of detector array 200. As a result, multiple active regions 202 may generate respective signals corresponding to a detected object from which the multiple received beams associated with beam spot 205 were reflected. The multiple detection signals may provide an increased resolution for a region of the detected object, where each active region 202 of detector array 200 represents a distinct pixel of a subregion within the region of the detected object.

A ratio of a distance between active regions of a detector and a distance between beam spots incident on the detector, may be a predetermined value. For example, a distance between beam spots formed by laser beams emitted from a laser array of LIDAR system 100 (e.g., laser array 150), i.e., corresponding to a distance between beam spots incident on a detector array of LIDAR system 100, may be a predetermined multiple of a distance or spacing between active regions of the detector array (e.g., active regions 202 of detector array 200), such as a multiple of: 0.5, 1.0, or 1.5. An angular dimension (e.g., angular width or height) of each beam spot (formed by emitted laser beams and/or reflected laser beams incident on the detector array) may also be a predetermined multiple of an angular dimension of an active region of the detector array, such as a multiple: of 0.5, 1.0, or 1.5.

LIDAR system 100 includes an optical window 124 (depicted in FIG. 1A) disposed between at least one system component and a scene to be imaged, such that light emitted from an emitter 156 of system 100 passes optical window 124 before reaching FOV 120, and/or light reflected from FOV 120 passes through optical window 124 before reaching a detector 132 of system 100. Optical window 124, also referred to herein generally as a “window”, may include light transmissive characteristics for passing through emitted light and/or reflected light. For example, window 124 may have high transmission properties respective of at least one characteristic of light emitted or received by system 100, such as being substantially transparent for a wavelength of the emitted and reflected light, such as to minimize propagation losses. Optical window 124 may be embodied by an opening, or by at least one optical element, such as a lens. Window 124 may be a portion of a housing configured to contain and protect one or more components of system 100, such as a housing containing emitter array 150 or detector array 130. Window 124 may be included as a component of system 100 or associated with at least one other system component. For example, window 124 may be associated with an optical assembly for manipulating one or more characteristics of emitted or reflected light via one or more optical elements, such as a beam splitter 140, a collimator 141, a light deflector 171, 173, or a lens 175. Additionally or alternatively, window 124 may be associated with vehicle 110 or another platform of system 100. For example, optical window 124 may be mounted on, embedded with, or included in a portion of vehicle 110, such as: a window, a windshield, a headlight, a grille, a roof, and a side mirror of vehicle 110. In one example, optical window 124 is disposed behind a windshield of vehicle 110. In another example, optical window is the windshield of vehicle 110, and LIDAR system 100 is integrated with the windshield of vehicle 110. Window 124 may be at least partially composed of glass, plastic, or any other suitable material. Window 124 be at least partially flat, curved, or any other suitable shape. Window 124 may provide a protective role, for protecting onc or more system components. Additionally or alternatively, window 124 may provide at least one optical function, such as redirecting, deflecting, collimating or focusing of light, filtering of selected wavelengths, and the like. Optical window 124 may be coated with a functional coating, such as an anti-reflective coating for maximizing light transmission through the window 124 and for minimizing losses due to back-reflections from the window surface. Optical window 124 may be coated on the exterior surface (i.e., the surface facing the external environment) with a functional coating that is hydrophobic or superhydrophobic. A hydrophobic coating may change the surface interaction with liquids on the window surface, increasing the contact angle and compelling liquid droplets to slide off the window surface.

In accordance with aspects of the present disclosure, the LIDAR system is configured to classify and determine characteristics of a window blockage of an optical window of the system. A window blockage, also referred to herein as a “blockage” or “obstruction”, may hinder or obstruct the passage of light through the window. A window blockage may result from various substances and materials present in an environment in which the LIDAR system operates. Examples of such substances may include but are not limited to: rain; snow; ice; hail; dew; precipitation; dirt; dust; sand; mud; soot; smog; insects; bird droppings; particulates; physical objects; and other miscellaneous debris and detritus. For example, a vehicle 110 of a vehicle-mounted LIDAR system 100 may be exposed to a variety of environmental substances over time, which may result in the formation of blockages of a window 124 of system 100. Such blockages may partially or fully impede the passage of emitted light or reflected light through window 124. In general, at least one optical path of LIDAR system 100 may be subject to a window blockage of window 124. A window blockage may be due to a blockage substance present directly on a surface of window 124. Alternatively, a window blockage may result from a blockage substance on a transmissive surface optically coupled to window 124, such as a windshield or window of vehicle 110, which may affect an optical path of emitted or reflected light through window 124. It is noted that a window blockage may be substantially opaque, such that substantially no light can pass through window 124, or a blockage may be at least partially translucent or transparent so as to allow passage of at least some light. It is further noted that a window blockage may limit an amount of incident light (e.g., reflections received from the FOV) and/or alter a direction or pathway of the incident light through window 124, such that the light may be steered away from an intended light reception path and may not reach intended sensors. A blockage may be present over only a limited portion of window 124 yet still adversely affect operation of LIDAR system 100.

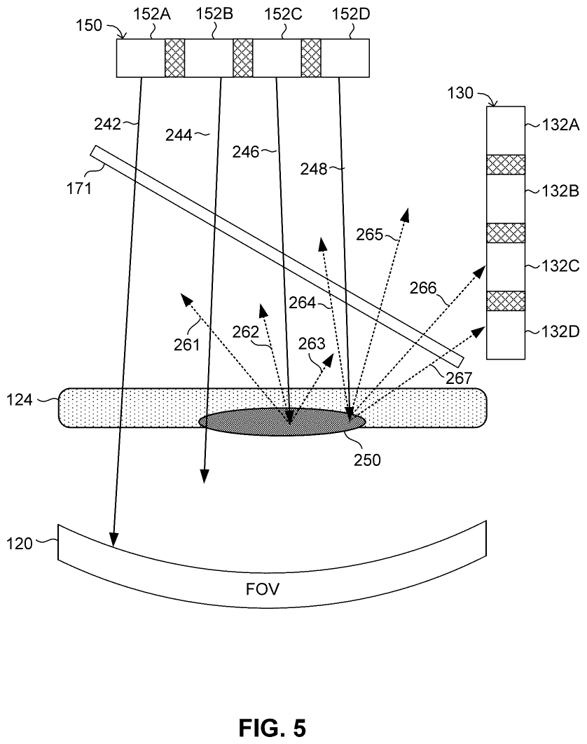

Reference is made to FIG. 5, which is an illustration of exemplary light emissions of a multichannel LIDAR system having a window blockage, operative in accordance with another embodiment of the present disclosure. A multichannel emitter array 150 emits multiple beams 242, 244, 246, 248 by respective emitters 152A, 152B, 152C, 152D. Emitted beams 242, 244, 246, 248 arc directed toward a FOV 120 through an optical window 124 on which a blockage 250 is present (where the optical path also includes an optional light deflector 171). Blockage 250 may impede or interfere with the passage of at least a portion of emitted beams 242, 244, 246, 248 through window 124, such as by reducing an intensity and/or altering a pathway or propagation direction of the emitted beams before reaching FOV 120. For example, emitted beam 242 is not incident on blockage 250 and reaches a region of FOV 120, whereas emitted beams 244, 246, 248 are impeded by blockage 250 from reaching FOV 120. At least a portion of the emitted beams obstructed by blockage 250 may undergo backscattering, producing blockage reflections that may reflect back towards LIDAR system 100. Some of the blockage reflections may be incident on a multichannel detector array 130 of system 100. For example, emitted beam 246 is backscattered by blockage 250, resulting in reflections 261, 262, 263 which may disperse in different directions. In another example, emitted beam 248 is backscattered by blockage 250, resulting in dispersed reflections 264, 265, 266, 267, where reflections 266, 267 are incident on respective detectors 132C, 132D of detector array 130.

In accordance with an aspect of the present disclosure, light is directed toward FOV 120 of LIDAR system 100 using a selected illumination protocol for blockage classification, such that an optical window 124 of system 100 is illuminated by a plurality of emitted beams at a plurality of illumination angles. For example, a first window portion of window 124 is illuminated by a first beam at a first angle of incidence, and a second window portion of window 124 is illuminated by a second beam at a second angle of incidence, whereby the first window portion and the second window portion at least partially overlap. Such an illumination protocol may allow for classifying or determining characteristics of a window blockage 250 of window 124.

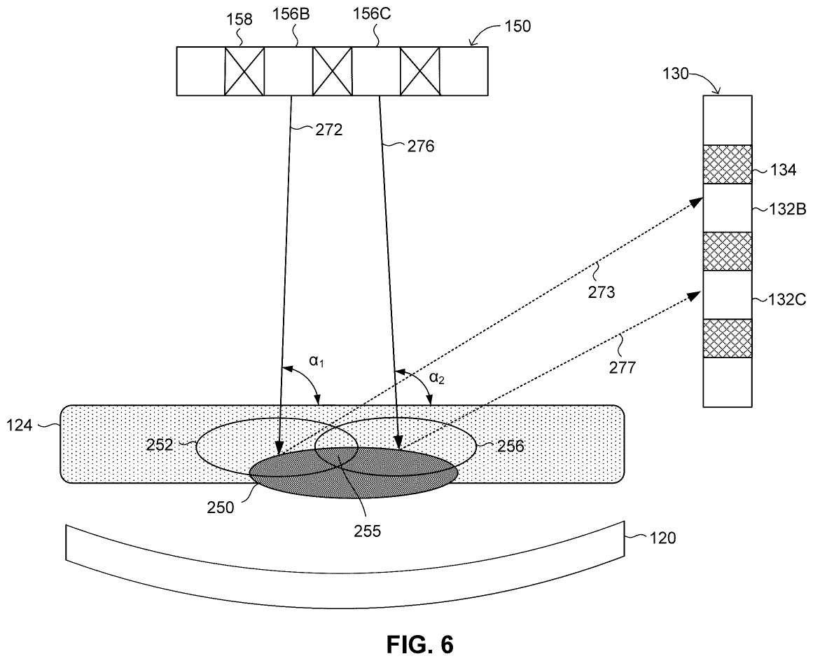

Reference is made to FIG. 6, which is an illustration of an illumination protocol for blockage classification in a multichannel LIDAR system having a window blockage, operative in accordance with an embodiment of the present disclosure. A multichannel emitter array 150 including a plurality of active regions or emitters 156 and a plurality of non-emitting inactive regions 158, emits multiple beams. In particular, first emitter 156A emits a first emitted beam 272 and a second emitter 156C emits a second emitted beam 276. In another example, a single emitter may emit both first beam 272 and second beam 276, such as a single emitter 156 of emitter array 150, or a single emitter not belonging to a multichannel array. More generally, emitted beams 272, 276 may be emitted by at least one laser emitter, and is described herein in the context of a multichannel emitter array for exemplary purposes only. First emitted beam 272 may be emitted at a first emission time, and second emitted beam 276 may be emitted at a second emission time. Emitted beams 272, 276 are incident on an optical window 124 having a blockage 250, where first emitted beam 272 is incident on window 124 at a first angle of incidence (AOI) or illumination angle α₁, and second emitted beam 276 is incident on window 124 at a second angle of incidence (AOI) or illumination angle α₂. In one example, a first emitter 156B emits first emitted beam 272 at first AOI α₁, and a second emitter 156C emits second emitted beam 276 at second AOI α2. In another example, first emitted beam 272 and second emitted beam 276 may be emitted by a common emitter 156, and directed at different illumination angles α₁, α₂ using at least one optical element of scanning unit 104. First emitted beam 272 illuminates a first region 252 of blockage 250, and second emitted beam 276 illuminates a second region 276 of blockage 250, where second region 276 at least partially overlaps with first region 252, such that a common blockage portion 255 of blockage 250 is illuminated by multiple beams 272, 276 at multiple illumination angles α₁, α₂. Blockage 250 may impede the passage of emitted beams 272, 276, and may produce one or more blockage reflections corresponding to a backscattering of emitted beams 272, 276. For example, first emitted beam 272 may be reflected back from blockage 250 as at least one first blockage reflection 273, and second emitted beam 276 may be reflected back from blockage 250 as at least one second blockage reflection 277. The direction, intensity, and other properties of blockage reflections 273, 277 may be a function of characteristics of blockage 250 as well as the illumination angle α₁, α₂ of the corresponding emitted beam 272, 276. For example, if window blockage 250 is characterized by a specular surface, which is generally smooth, such as a surface of a liquid (e.g., a water droplet), the blockage 250 may produce a specular reflection, i.e., such that the angle of the reflected light equals the angle of incident light but on an opposite side of the surface normal in the plane formed by the incident and reflected rays. Additionally, a droplet of liquid may be highly reflective due to its shape and multiple reflections within the droplet may result in high backscatter reflections. In another example, if window blockage 250 is characterized by a non-specular surface, which is generally rough or non-smooth, such as a surface of a solid material (e.g., dust or dirt particles), the blockage 250 may produce a diffuse reflection, such that the incident light is scattered at multiple angles in multiple directions.

Blockage reflections 273, 277 are reflected from window blockage 250 and may be incident on a multichannel detector array 130. For example, first blockage reflection 273 of first emitted beam 272 is received by a first detector 132B of detector array 130, and second blockage reflection 277 of second emitted beam 276 is received by a second detector 132C of detector array 130. In another example, a single detector may receive both first blockage reflection 273 and second blockage reflection 277, such as a single detector 132 of detector array 130, or a single detector not belonging to a multichannel array. More generally, blockage reflections 273, 277 may be received by at least one detector, and is described herein in the context of a multichannel detector array for exemplary purposes only. Blockage reflections 273, 277 may pass through once or more internal optical elements (not shown) of the LIDAR system before reaching detector array 130. The angle of incidence and other properties of blockage reflections 273, 277 may be a function of the illumination angles α₁, α₂ of the emitted beams 272, 276 and the properties of window blockage 250. For example, the illumination angles may be intervals of approximately 0.5-3 degrees. Detector array 130 may differentiate between received FOV reflections and received window blockage reflections based on time-of-flight (TOF) characteristics. Short-range reflections (such as from an optical window 120 of the LIDAR system) are generally stronger and have a higher intensity than long-range reflections, such that a high intensity may also provide an indication of a window blockage reflection.

Emitting beams at different illumination angles may be achieved by various means. In one example, different emitters 156 of emitter array 150 may be activated sequentially, such that a spatial separation between the emitters 156 produces an angular disparity of the emitted beams after transmission through a lens. In another example, a single emitter may be split into multiple beams with a beam splitter, producing a plurality of beams with an angular separation. In another example, at least one emitter may be activated, and an illumination angle of the emitted beam may be set or adjusted using scanning unit 104, such as based on a comparison of subsequent emissions. For example, an adjusted illumination angle may be obtained using various scanning techniques and optical components (e.g., mirrors or deflectors), as described hereinabove.

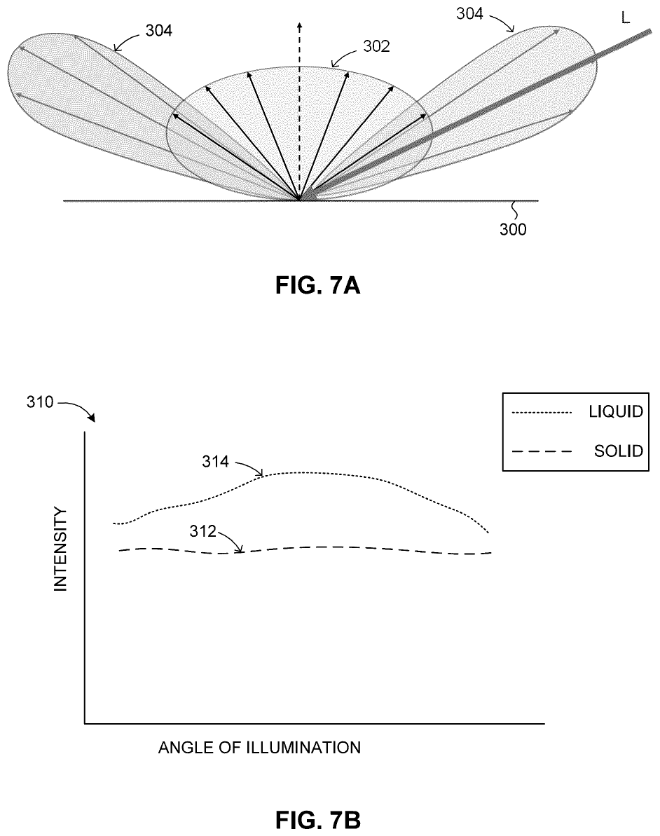

According to an aspect of the present disclosure, a processor 118 may determine characteristics of a window blockage 250, such as a classification thereof, based on received reflections. In particular, processor 118 may determine characteristics of blockage 250 based on received blockage reflections (273, 277) resulting from the illumination angles of the corresponding emitted beams (272, 276). For example, different types or categories of blockages may produce reflections having different intensity profiles as a function of illumination angle. Reference is made to FIG. 7A, which is a spatial representation overlay pattern of reflections resulting from emissions incident on exemplary window blockages, operative in accordance with an embodiment of the present disclosure. “L” represents a chief ray of an illuminating (emitting) light beam, which is emitted toward an optical interface 300, such as an optical window of a LIDAR system. Reflection pattern 302 is characteristic of diffuse reflections of light incident on a rough solid blockage (not shown) of optical interface 300, such as a dust particle or mud splatter. The reflections are relatively uniform in each direction as they reflect off the blockage, following a Lambertian reflectance pattern. Reflection patterns 304 is characteristic of a specular reflection from a liquid or other specular surface. The liquid may be a droplet having a curvature, whereby light incident thereon is reflected from a curved surface. Incident rays are reflected at a particular angle depending on the surface and the angle of incidence, i.e., in contrast with reflection pattern 302 where the incident rays are dispersed in multiple directions. Reflection pattern 304 of the specular surface is also characterized by a relatively larger peak intensity, as compared to reflection pattern 302 of the non-specular surface. In one example, the blockage may be located on a side of the optical window facing the environment, while the light incident thereon may be emitted by a laser emitter on an opposite side of the optical window, such that the light is incident on a side of the optical window facing the LIDAR system and transmitted through the optical window towards a blockage.

Reference is further made to FIG. 7B, which a graph, generally referenced 310, illustrating reflection intensity profiles of exemplary window blockage reflections as a function of angle of illumination of corresponding emissions, operative in accordance with an embodiment of the present disclosure. Graph 310 shows a pair of profiles 312, 314, each representing the intensity of received reflections from a particular type of window blockage 250 as a function of the angle of illumination (AOI) of the corresponding emissions incident on the blockage 250. The illumination angles may be emitted at intervals of approximately 0.5-3 degrees, and the span of angles used to generate the intensity profile may be at least 5 degrees. It is noted that a reflection intensity profiles for a clean window with no blockage may be subtracted from an obtained reflection intensity profile, in order to distinguish between reflections internal to the LIDAR system (referred to as “parasitic reflections”), and reflections due to objects outside the system (e.g., window blockages). A first intensity profile 312 represents a solid blockage of window 124, such as dust, and a second intensity profile 314 represents a liquid blockage of window 124, such as water droplets (e.g., due to rain or snow). It is noted that the liquid profile 314 differs from the solid profile 312, such as by exhibiting a greater peak intensity. More specifically, reflection intensity profile 312 is generally characterized by a Lambertian reflectance pattern, such that the reflected radiant intensity obeys Lambert's cosine law and the reflected radiance is substantially constant for all angles. In contrast, reflection intensity profile 314 does not exhibit a Lambertian reflectance pattern, but may have other characteristics features, such as variable a peak height greater than a threshold value and a peak width (FWHH) smaller than a threshold value.

Accordingly, processor 118 may process a reflection intensity profile as a function of AOI of received blockage reflections, in order to categorize a window blockage 250, such as by comparing with known reflection intensity profile patterns, which may be accessible in a database or lookup table. For example, if the received intensity/AOI reflection profile corresponds to a Lambertian pattern (e.g., is substantially uniform over multiple AOI angles, similar to profile 312), then the blockage may be classified as a solid blockage, whereas if the received intensity/AOI reflection profile does not correspond to a Lambertian pattern (e.g., is substantially variable and has a peak intensity above a threshold value, similar to profile 314), then the blockage may be classified as a liquid blockage. Processor 118 may also process additional characteristics for classifying the blockage 250, such as further properties of the emissions and/or reflections in addition to intensity of reflections and AOI of emissions. Such further properties may include: radiant intensity; peak power; beam width; wavelength; frequency; operating mode; modulation; timing; number of pulses in a pulse sequence; and overall light flux. The blockage classification may also account for additional relevant factors, such as a sensitivity level of a detector 132, or a reflectivity of an object in the FOV.

Further to the blockage classification, processor 118 may determine additional information relating to the window blockage. The determined information may include at least one of: a location of the window blockage (e.g., in relation to the optical window); a size of the blockage; a shape of the blockage; a transparency of the blockage; and a cleaning mechanism for clearing the blockage. The determination may be based on at least one of: an AOI (of at least a first emitted beam at a first AOI and at least a second emitted beam at a second AOI); a position and orientation of an optical element of the LIDAR system (e.g., a light deflector used to redirect an emitted beam and/or a reflection); an intensity, a form, and a timing of an emitted beam or a reflection; and the like. Processor 118 may also utilize a baseline signal corresponding to a reflection received from a clean window 124 without a blockage, for calibration or reference. Accordingly, processor 118 may compare parameters of reflection signals received through a window 124 having a blockage 250 to expected parameters in the baseline signal corresponding to a clean window, for determine blockage characteristics. If window 124 includes a functional coating, such as a hydrophobic or superhydrophobic coating, processor 118 may be configured to monitor the status of such a functional coating, such as changes in reflection profiles of droplets on a hydrophobic coating.

In one example, one or more emitters is activated sequentially to produce multiple illuminations of a window blockage at a plurality of illumination angles. Referring back to FIG. 6, at a first time t₁ a first emitter 156B of emitter array 150 emits a first beam 272 to illuminate a first blockage region 252 of window blockage 250 at a first AOI α₁. At a second time t₂ (e.g., subsequent to first time t₁), a second emitter 156C of emitter array 150 emits a second beam 276 to illuminate a second blockage region 256 of window blockage 250 at a second AOI α₂, where the second blockage region 256 at least partially overlaps the first blockage region 252. Detector array 130 receives blockage reflections 273, 277 corresponding to emitted beams 272, 276 at different times, and the reflection patterns may be processed to enable a classification of the blockage 250, such as based on intensity vs AOI profiles). In another example, a single emitter may be activated, and a scanning unit may deflect at least one emitted beam from the emitter to produce multiple illuminations of a window blockage at a plurality of illumination angles. In a further example, a plurality of emitters may be activated simultaneously and a scanning unit may be sequentially shifted to produce multiple illuminations of a window blockage at a plurality of illumination angles. For example, at a first time t₁, a light deflector (not shown) of a scanning unit 104 of LIDAR system 100 is shifted to a first scanning position to direct first beam 272 emitted by first emitter 156B to illuminate first window region 252 of blockage 250 at first AOI α₁. At a second time t₂, the light deflector is shifted to a second scanning position to direct second beam 276 emitted by second emitter 156C to illuminate second window region 256 of blockage 250 at second AOI α₂. Detector array 130 receives blockage reflections 273, 277 corresponding to emitted beams 272, 276 at different times, and the reflection patterns may be processed to enable a classification of the blockage 250, such as based on reflection intensity profiles as a function of AOI.

According to another aspect of the present disclosure, the processing may utilize at least one machine learning model to determine characteristics of a window blockage 250. A machine learning based model may be configured to process information relating to reflections and emissions of a blockage classification illumination protocol, such as reflection intensity profiles, to extract blockage characteristics based on identified patterns and classification categories. The machine learning based model may utilize machine learning techniques to determine blockage characteristics patterns and profiles based on historical data as well as reference data provided during an initial learning stage. More generally, the data analysis may utilize any suitable machine learning or supervised learning process or algorithm known in the art, including but not limited to: a neural network (e.g., an artificial neural network, a recurrent neural network); a deep learning algorithm; a regression model (e.g., linear regression, logistic regression); and/or a combination thereof.

According to an aspect of the present disclosure, LIDAR system 100 may apply one or more corrective measures or remedial actions in response to a determination of a window blockage 250 on a window. The type of corrective measure, and the manner in which the corrective is applied, may be established based on a determined classification and/or other characteristics of the window blockage 250. For example, a corrective measure may include an activation of a cleaning process, such as by applying a cleansing agent (e.g., compressed air, a chemical solution, water) to window 124. For example, a liquid-based cleansing solution (such as a spray cleaning fluid) may be unnecessary for clearing a liquid blockage, for which no cleaning may be needed, or for which an alternate cleaning process may be more suitable, such as compressed air. It may be helpful to limit the application of a cleaning fluid such that it is utilized only for suitable blockages, such as solid blockages, so as to avoid the need for maintaining a large quantity of the cleaning fluid. Various aspects of the cleaning process, such as: the applied location on window 124, the type of cleaning technique; the type of cleaning agent; the cleaning time period, may be determined according to: a determined category of the blockage 250 a determined location of blockage 250; a determined quantity of blockage 250; and other relevant blockage characteristics. Processor 118 may communicate blockage information to an internal or external system module, for determining a suitable corrective measure and manner of application.

LIDAR system 100 may activate (initiate) and/or deactivate (cease) a blockage classification illumination protocol at regular or irregular intervals, or responsive to one or more trigger conditions. For example, LIDAR system 100 may activate (and/or deactivate) a blockage classification illumination protocol at predefined instances, such as for one or more measurements in selected frames (scanning cycles) of a sequence of frames, or at selected time intervals for a selected duration. In another example, LIDAR system 100 may activate (and/or deactivate) a blockage classification illumination protocol at variable or random instances, such as for random frames (or random positions in frames) of a frame sequence, or at random time intervals. In a further example, LIDAR system 100 may activate a blockage classification illumination protocol responsive to a previous detection of a window blockage, such as a positive (e.g., low-resolution) detection of a blockage with a probability that exceeds some minimum threshold. Correspondingly, LIDAR system 100 may deactivate a blockage classification illumination protocol responsive to a non-detection of a window blockage, such as when a positive (e.g., low-resolution) detection of a blockage is below some minimum threshold.

According to an aspect of the present disclosure, LIDAR system 100 may operate as a rain sensor. In particular, LIDAR system 100 may determine a classification of a liquid blockage of a window, where the liquid blockage may be indicative of rain or other forms of precipitation in the external environment. LIDAR system 100 may detect and establish a rain event alert, such as responsive to repeated detections of a window blockage classified as a liquid or droplets. The rain event alert may be communicated to vehicle 110 or any external processor, and one or more rain treatment mechanisms may be activated accordingly. For example, LIDAR system 100 may be mounted behind the windshield of a vehicle 110 and detect a rain event in an environment where vehicle 110 is operating, responsive to a positive detection of a window blockage classified as a liquid, such as due to a liquid blockage on the windshield. Vehicle 110 may receive a rain event alert and may activate windshield wipers responsive to the alert. This may eliminate the need for employing a separate dedicated sensor for detecting rain or precipitation, such as those commonly found in vehicles.

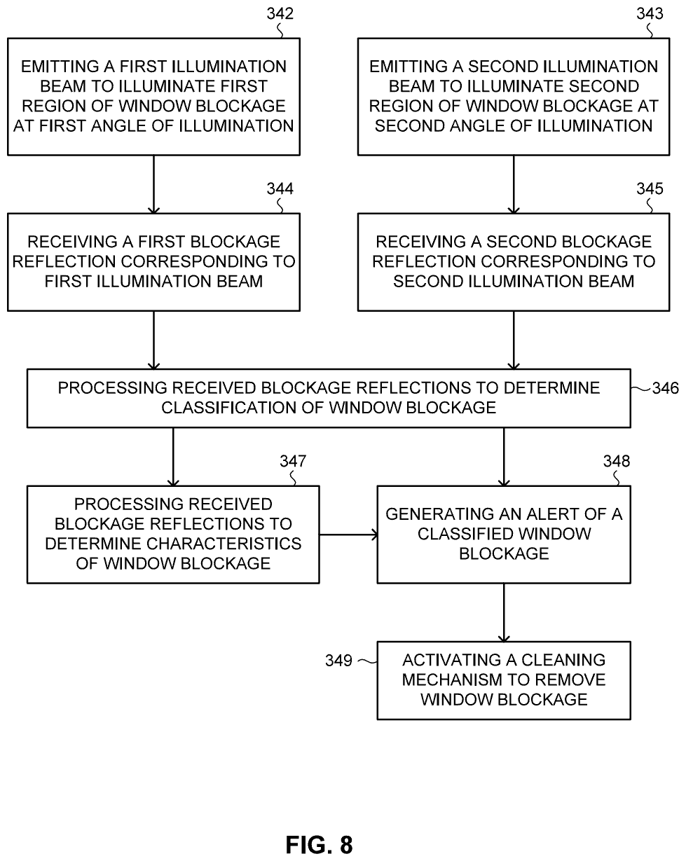

Reference is made to FIG. 8, which is a flow diagram of a method for determining a classification of a window blockage of a multichannel LIDAR system, operative in accordance with an embodiment of the present disclosure. In a step 342, a first illumination beam is emitted to illuminate a first region of a window blockage at a first angle of illumination. Referring to FIG. 6, first emitter 156B of emitter array 150 emits a first beam 272 to illuminate a first region 252 of window blockage 250 at a first AOI α₁. In another example, first beam 272 illuminating first blockage region 252 may be emitted from an emitter not belonging to an emitter array.

In a step 343, a second illumination beam is to illuminate a second region of a window blockage at a second angle of illumination. Referring to FIG. 6, second emitter 156C of emitter array 150 emits a second beam 276 to illuminate a second region 256 of window blockage 250 at a second AOI α₂, where second blockage region 256 at least partially overlaps first blockage region 252. Second beam 276 illuminating second blockage region 252 may alternatively be emitted from an emitter not belonging to an emitter array, and/or from a same emitter that emits first beam 272. Second beam 276 may be emitted at a second time subsequent to a first time at which first beam 272 is emitted. An angular disparity between second AOI α₂ of second beam 276 and a first AOI a of first beam 272 may result from a spatial separation between emitters 156B, 156C of emitter array 150, and or may be established or adjusted by one or more light deflection elements of a scanning unit 104.

In a step 344, a first blockage reflection corresponding to the first illumination beam is received. Referring to FIG. 6, first detector 132B of detector array 130 receives a first blockage reflection 273 corresponding to the illumination of blockage 250 at first AOI α₁ by first beam 272. In another example, first blockage reflection 273 may be received by a detector not belonging to a detector array.

In a step 345, a second blockage reflection corresponding to the second illumination beam is received by the multichannel detector array. Referring to FIG. 6, second detector 132C of detector array 130 receives a second blockage reflection 277 corresponding to the illumination of blockage 250 at second AOI α₂ by second beam 276. Second blockage reflection 277 may alternatively be received by a detector not belonging to a detector array, and/or by a same detector that receives first blockage reflection 273.

In a step 346, reflection characteristics of the received blockage reflections are processed to determine a classification of the window blockage. Referring to FIGS. 1 and 6, processor 118 of LIDAR system 100 processes reflection characteristics of first blockage reflection 273 and second blockage reflection 277 received by detector array 130, to determine a classification of window blockage 250. For example, a blockage classification may be established based on an intensity profile of the blockage reflections as a function of AOI of corresponding illumination beams. For example, a reflection profile that corresponds to a Lambertian reflectance pattern, and which may be substantially uniform over AOI values (similar to profile 312 of FIG. 7A) may be designated as a solid blockage, whereas a reflection profile that does not correspond to a Lambertian reflectance pattern, and which may be substantially variable and having a peak intensity above a threshold (similar to profile 314 of FIG. 7A) may be designated as a liquid blockage. For example, a diffuse reflection pattern that is scattered substantially uniformly in multiple directions (similar to reflection pattern 302 of FIG. 7B) may be associated with a solid blockage or a blockage having a non-specular rough surface, whereas a non-diffuse reflection pattern having a defined reflection angle (similar to reflection pattern 304 of FIG. 7B) may be associated with a liquid blockage or a blockage having a specular surface.

In a step 347, reflection characteristics of the received blockage reflections are processed to determine information relating to the window blockage. Referring to FIGS. 1 and 6, processor 118 of LIDAR system 100 processes reflection characteristics of first blockage reflection 273 and second blockage reflection 277 received by detector array 130, to determine further information or characteristics of window blockage 250. For example, processor 118 may determine a location on window 124, a size or shape, and/or a transparency of the window blockage 250, or a selected cleaning mechanism to employ for removing the blockage 250. The determination may be based on characteristics of blockage reflections 273, 277 and corresponding illumination beams 272, 276, such as: intensity, angles, form, modulation, wavelength, timing, and the like. The determination may also use as a reference a baseline signal representing reflections from a clean window 124 (i.e., not having a blockage 250).

In an optional step 348, an alert of a classified window blockage is generated. Referring to FIGS. 1 and 6, processor 118 of LIDAR system generates an alert of a window blockage 250 based on a determined blockage classification. For example, processor 118 may generate an alert of a classified blockage, such as a liquid blockage or a solid blockage, according to a blockage classification established based on processing of the blockage reflections. The alert may be transmitted to an external control system or a control system of vehicle 110 on which LIDAR system 100 is mounted. An alert may include sub-categories associated with a liquid blockage or solid blockage or include additional blockage characteristics. For example, processor 118 may generate a rain event alert following a detection of a liquid blockage for a repeated period (e.g., for at least a minimal threshold duration), which may be communicated to a controller of vehicle 110 for activating a rain treatment mechanism.

In an optional step 349, a cleaning mechanism is activated to remove the window blockage. Referring to FIGS. 1 and 6, one or more cleaning mechanisms is activated to remove a window blockage 250 of window 124, responsive to a generate alert of a classified window blockage 250. The cleaning mechanism activation may be implemented by LIDAR system 100, by vehicle 110 (i.e., elements associated with vehicle 110), or by an external control system. A selected blockage cleansing agent may be applied, such as compressed air, a chemical solution, a spray cleaner or cleaning fluid, to clear or remove the classified window blockage 250, For example, a liquid-based cleaning mechanism, such as a spray cleaning fluid, may be applied to remove a solid blockage, while a compressed air cleaning mechanism may be applied to remove a liquid blockage (e.g., for which a liquid-based cleanser may be wasteful and unnecessary). The application of the selected cleaning mechanism may be in accordance with the determined characteristics of the blockage 250. For example, the applied location on window, and the type, intensity and duration of the selected cleaning mechanism may be established based on blockage characteristics, such as a determined classification, a location of blockage 250 on window 124, a determined quantity or severity of blockage 250, and the like.

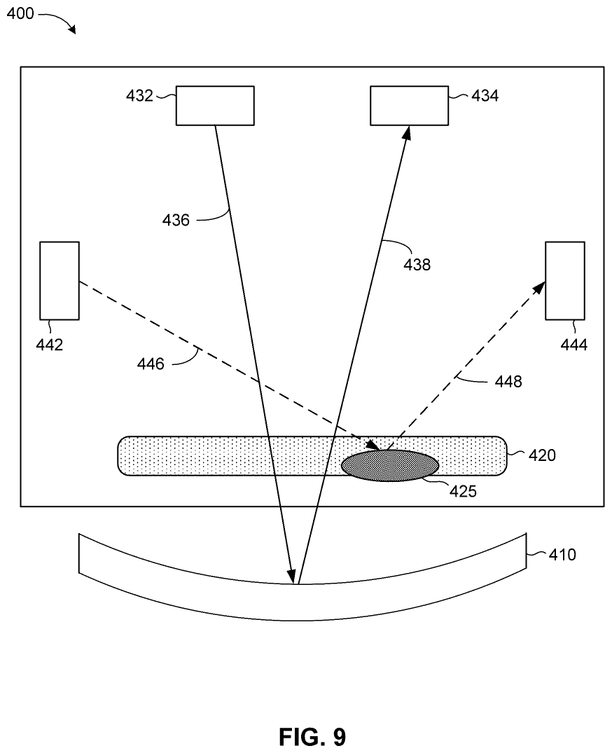

In another embodiment, a LIDAR system may incorporate a dedicated illumination unit for detecting and classifying window blockages, such as a non-LIDAR illumination. In some examples, LIDAR-based illumination and light emitting diode (LED)-based illumination are utilized. Reference is made to FIG. 9, which illustrates a LIDAR system 400 incorporating LED illumination for detecting and classifying window blockages, constructed and operative in accordance with an embodiment of the present disclosure. LIDAR system 400 includes an optical window 420 through which a field of view (FOV) 410 is scanned. A window blockage 425 may be present on the optical window 420. LIDAR system 400 includes a LIDAR emitter array 432 configured to emit LIDAR illumination 436 along a first optical axis. LIDAR illumination 436 passes through the optical window 420 to illuminate FOV 410. A LIDAR detector array 434 is configured to receive LIDAR reflections 438 from FOV 410.

In addition to the LIDAR components, LIDAR system 400 includes a dedicated LED emitter 442 and LED detector 444 for blockage classification. LED emitter 442 is configured to emit LED illumination 446 along a second optical axis, different from the first optical axis of the LIDAR illumination. This LED illumination 446 is specifically directed to illuminate the optical window 420. When a blockage 425 is present on the optical window 420, the LED illumination 446 interacts with blockage 425, producing LED reflection 448. This LED reflection 448 is captured by LED detector 444, which may be positioned to optimally receive reflections from the optical window 420.

LED illumination 446 may include a first illumination beam emitted at a first AOI and a second illumination beam emitted at a second AOI, and correspondingly, LED reflection 448 may include a first blockage reflection of the first illumination and a second blockage reflection of the second illumination beam (for convenience, only a single LED illumination and a single LED reflection is depicted in FIG. 9). A processor (not shown) may be configured to analyze the characteristics of the blockage reflections of LED reflection 448 received by the LED detector 444 to determine a classification of window blockage 425. This analysis may involve examining the intensity, pattern, or other properties of the LED reflection 448. The processor may apply similar techniques as described for the LIDAR-based blockage detection, such as analyzing reflection intensity profiles at different angles of incidence, to classify the blockage, such as a solid or liquid classification and/or a specular or non-specular classification.

The use of a separate LED-based illumination and detection unit for blockage classification may offer several potential benefits. The LED emitter 442 and LED detector 444 may be positioned and oriented specifically for optimal blockage detection, without interfering with the primary LIDAR scanning functions. This configuration allows for continuous or periodic monitoring of the optical window 420 for blockages, even while the LIDAR system is actively scanning the field of view 410. In some implementations, the LED emitter 442 and LED detector 444 may be positioned on opposite sides of the optical window 420, as shown in FIG. 9. This arrangement may provide an advantageous geometry for detecting certain types of blockages or for distinguishing between different blockage characteristics.

LIDAR system 400 may be configured to use both LIDAR-based and LED-based blockage classification methods in a complementary manner. For example, the LED-based unit might provide continuous monitoring for blockages, while the LIDAR-based unit performs more detailed classification when a blockage is detected. Alternatively, the two methods might be used for cross-validation or to provide more comprehensive blockage characterization. By incorporating both LIDAR and LED illumination sources, LIDAR system 400 offers a versatile approach to window blockage detection and classification, potentially improving the reliability.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A LIDAR system, comprising:
an emission unit comprising at least one emitter, configured to emit a first illumination beam to illuminate at a first angle of illumination (AOI) a first blockage region of a window blockage of an optical window, and configured to emit a second illumination beam to illuminate at a second AOI a second blockage region of the window blockage, the second blockage region at least partially overlapping the first blockage region;
a sensing unit, comprising at least one detector, configured to receive a first blockage reflection of the first illumination beam, and to receive a second blockage reflection of the second illumination beam, the first blockage reflection having a first reflection intensity, and the second blockage reflection having a second reflection intensity; and
a processor, configured to determine a classification of the window blockage, based on the first reflection intensity of the first blockage reflection and the first AOI of the first illumination beam, and based on the second reflection intensity of the second blockage reflection and the second AOI of the second illumination beam.

2. The LIDAR system of claim 1, wherein the blockage is classified into a blockage category selected from the group consisting of: a liquid; a solid; a blockage having a specular surface; and a blockage having a non-specular surface.

3. The LIDAR system of claim 1, wherein the classification of the window blockage is based on a reflection intensity profile of intensity of received blockage reflections as a function of AOI of corresponding emitted illumination beams.

4. The LIDAR system of claim 3, wherein determining a classification of the window blockage comprises determining a solid blockage or a non-specular blockage when the reflection intensity profile is characterized by a Lambertian pattern, and determining a liquid blockage or a specular blockage when the reflection intensity profile is not characterized by a Lambertian pattern.

5. The LIDAR system of claim 1, wherein the first illumination beam and the second illumination beam are emitted from at least one emitter of an emitter array of the emission unit.

6. The LIDAR system of claim 1, wherein the first illumination beam and the second illumination beam are emitted sequentially.

7. The LIDAR system of claim 1, further comprising a scanning unit, configured to direct the first illumination beam to the first blockage region at the first AOI, and to direct the second illumination beam to the second blockage region at the second AOI.

8. The LIDAR system of claim 1, wherein the emitter is selected from the group consisting of: a laser emitter; and a light emitting diode (LED) emitter.

9. The LIDAR system of claim 1, wherein at least one cleaning mechanism for cleaning the window blockage is configured to be activated responsive to a classified window blockage.

10. The LIDAR system of claim 7, wherein the processor is configured to control at least one of the emission unit and the scanning unit to illuminate the first blockage region by the first illumination beam at the first AOI, and to illuminate the second blockage region by the second illumination beam at the second AOI, according to a blockage classification illumination protocol, wherein the processor is configured to apply the blockage classification illumination protocol during at least one of: predefined intervals; random intervals; and responsive to a detection of the window blockage.

11. The LIDAR system of claim 1, wherein the window is a portion of a vehicle.

12. The LIDAR system of claim 1, wherein a rain treatment mechanism is activated responsive to a determined classification of a liquid blockage indicative of a precipitation state in an environment of the LIDAR system.

13. A method for determining a classification of a window blockage in a LIDAR system, the method comprising:
emitting a first illumination beam to illuminate at a first angle of illumination (AOI) a first blockage region of a window blockage of an optical window;
emitting a second illumination beam from to illuminate at a second AOI a second blockage region of the window blockage, the second blockage region at least partially overlapping the first blockage region;
receiving a first blockage reflection corresponding to the first illumination beam, the first blockage reflection having a first reflection intensity;
receiving a second blockage reflection corresponding to the second illumination beam, the second blockage reflection having a second reflection intensity; and
determining a classification of the window blockage, based on the first reflection intensity of the first blockage reflection and the first AOI of the first illumination beam, and based on the second reflection intensity of the second blockage reflection and the second AOI of the second illumination beam.

14. The method of claim 13, wherein the blockage is classified into a blockage category selected from the group consisting of: a liquid; a solid; a blockage having a specular surface; and a blockage having a non-specular surface.

15. The method of claim 13, wherein determining a classification of the window blockage comprises processing a reflection intensity profile of intensity of received blockage reflections as a function of AOI of corresponding emitted illumination beams.

16. The method of claim 15, wherein determining a classification of the window blockage comprises determining a solid blockage or a non-specular blockage when the reflection intensity profile is characterized by a Lambertian pattern, and determining a liquid blockage or a specular blockage when the reflection intensity profile is not characterized by a Lambertian pattern.

17. The method of claim 13, wherein the first illumination beam and the second illumination beam are emitted sequentially.

18. The method of claim 13, wherein the first illumination beam is directed to the first blockage region at the first AOI by a scanning unit, and wherein the second illumination beam is directed to the second blockage region at the second AOI by the scanning unit.

19. The method of claim 15, wherein at least one machine-learning generated classification model is applied to the reflection intensity profile, the classification model configured to determine a classification of the blockage based on at least one pattern detected in the reflection intensity profile.

20. The method of claim 13, further comprising activating a rain treatment mechanism responsive to a determined classification of a liquid blockage indicative of a precipitation state in an environment of the LIDAR system.
